(19) United States
(12) Patent Application Publication
(10) Pub. No.: US 2012/0023124 A1
(43) Pub. Date: Jan. 26, 2012

(54) SOCIAL NETWORKING COMMUNICATION INTERFACE SYSTEM AND METHOD

(76) Inventors: TOBIN BIOLCHINI, Tulsa, OK (US); JAMES GERARD MILLAWAY, Tulsa, OK (US)

(21) Appl. No.: 12/840,011

(22) Filed: Jul. 20, 2010

(51) Int. Cl. G06F 17/30

(52) U.S. Cl. 707/769; 707/E17.014

(57) ABSTRACT

A communications system includes a central server that communicates with a plurality of query servers for exchanging queries and receiving query responses. The system also includes a querying device that communicates with the central server to send queries thereto and receive query responses therefrom. The querying device sends a query to the central server that posts the query to each of the plurality of query servers. At least one third party provides a query response to the query on at least one of the plurality of query servers. The central server receives the response to the query from the at least one of the plurality of query servers and provides the response to the querying device.

### FIELD OF THE INVENTION

This disclosure relates to communications systems in general and, more specifically, to communication with social networking sites.

### BACKGROUND OF THE INVENTION

Those who undertake activities on various social networking sites will understand the utility provided. These sites are often used to keep track of old acquaintances, and for non-time or location critical information exchange. In this respect, social networking sites operate in a similar manner as a bulletin board. However, with more and more users accessing these sites, and more frequently, the utility of these sites and services could be enhanced.

Often when users are away from home or work, a simple answer to a question from friends or contacts could prove extremely helpful. An example could be: “Where can I get good sushi?” Another example might be: “Where is the best car wash?” Of course, one may begin calling each friend with knowledge of the area or subject matter but this is time consuming and often inconvenient. Moreover, it is not always known who will have a good answer to such a query. It is unlikely that one knows what each of his or her friends thinks of sushi in general, and would therefore be able to recommend a quality establishment.

Social networking sites offer a solution to obtaining answers to these queries but, until now, do not provide an optimal solution to the timing question. One can login to each social networking site of which one is a member, post the query, and continually monitor for appropriate responses. Obviously, this presents problems, and these are multiplied by the number of social networking sites queried. The need to answer these questions will often arise when one is in a social situation or otherwise engaged such that spending time posting and monitoring queries is not feasible. Additionally, many queries would be time sensitive, and answers provided long after the fact may not be useful (for example, “Where can I get an oil change at lunch?”, or “my babysitter canceled, does anyone have a recommendation?”).

What is needed is a system and method for addressing the above, and related, problems.

### SUMMARY OF THE INVENTION

The invention of the present disclosure, in one aspect thereof comprises a communications system. The system includes a central server that communicates with a plurality of query servers for exchanging queries and receiving query responses. The system also includes a querying device that communicates with the central server to send queries thereto and receive query responses therefrom. In one method of operation, the querying device sends a query to the central server that posts the query to each of the plurality of query servers. At least one third party provides a query response to the query on at least one of the plurality of query servers. The central server receives the response to the query from the at least one of the plurality of query servers and provides the response to the querying device. The querying device may also supply a reply to at least one response, which may be received by the central server and sent to the plurality of query servers.

In some embodiments the central server obtains location data from the querying device when receiving the query. The central server may provide the location data as a part of the query posted to the plurality of query servers. Each of the plurality of query servers may receive login credentials from the central server corresponding to a user issuing the query from the querying device.

In one embodiment, at least one of the plurality of query servers is a social networking server. The querying device is a mobile computing device or a stationary computing device. It may communicate with the central server via a mobile phone network or by the Internet.

### BRIEF DESCRIPTION OF THE DRAWINGS

FIG. 1 is a schematic diagram of a communications system according to aspects of the present disclosure.

FIG. 2 is another schematic diagram of a communications system according to aspects of the present disclosure.

FIG. 3 is a sequence diagram illustrating one possible sequence of communications within the systems described in the present disclosure.

FIG. 4 is a flowchart depicting one embodiment of a method of operation of the communications systems described in the present disclosure.

### DETAILED DESCRIPTION OF THE PREFERRED EMBODIMENTS

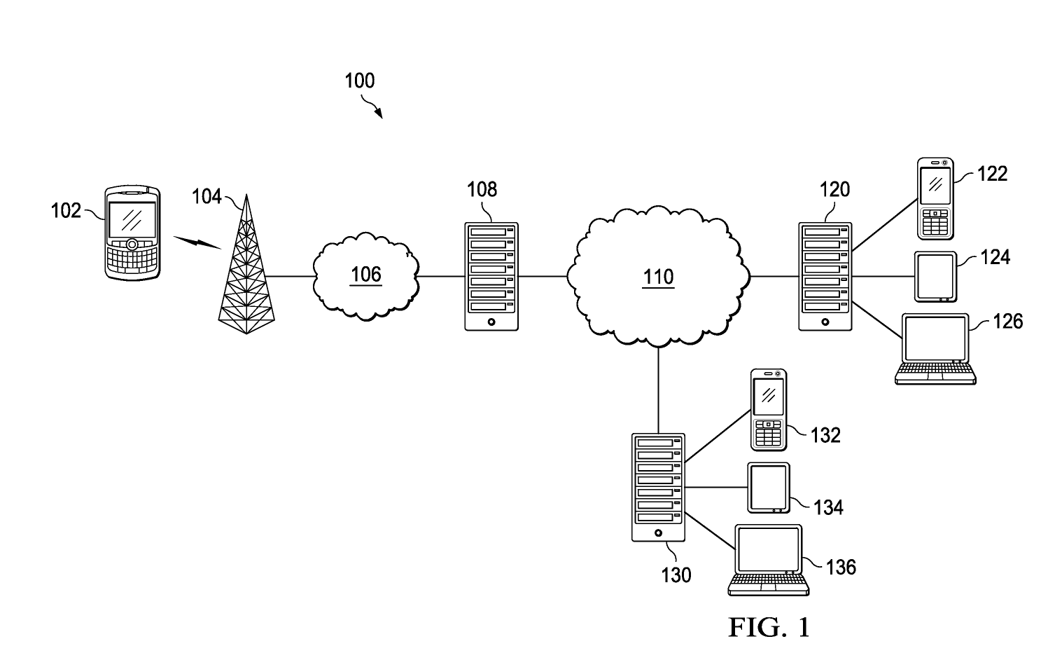

Referring now to FIG. 1 a schematic diagram of a communications system 100 according to aspects of the present disclosure as shown. In the present embodiment, a mobile device 102 communicates wirelessly with a wireless communication tower 104. The tower 104 may be coupled to a central server 108 via a data network 106. The central server 108 communicates over the Internet 110 with social networking servers or query servers 120 and 130. It can be seen that the social networking server 120 provides access for a number of users using devices 122, 124, and 126. In the present embodiment, a mobile phone 122, a tablet computer 124 and a laptop computer 126 are shown communicatively coupled to the social networking server 120. It is understood that a social networking server may have many users attached (e.g., via the Internet) simultaneously and the number of users connected may vary over time. The social networking server 130 is shown attached to a user's mobile phone 130, tablet computer 132 and laptop computer 136.

The mobile device 102 of the present embodiment may be any personal communication device capable of issuing a query to the central server 108. Examples include, but are not limited to, mobile phones, personal media players, tablet computers, laptop computers, desktop computers, and other devices. In the present embodiment, the mobile communications device 102 may be any device capable of accessing a social networking site. However, ability to connect to the social networking site is not required so long as the device 102 can communicate with the central server 108 and act as a querying device.

The mobile device 102 of the present disclosure communicates via a cellular telephone network to the cellular tower 104. This communication may be done over a 3G network, a GSM network, a CDMA network, a TDMA, or other type of network capable of supporting transmission of data. FIG. 1 illustrates the cellular network (shown as tower 104) connecting to a central server 108 through a data network 106. In the present embodiment, the data network 106 is provided as a part of the cellular communication system and is configured to transmit data packets instead of, or in addition to, voice data. The data network 106 allows for exchange of data between the mobile device 102 and the central server 108. This data will be utilized through the central server 108 to communicate with the social networking servers 120, 130 as will be described in greater detail below.

The central server 108 may connect to a plurality of social networking servers. The present embodiment illustrates two social networking servers 120, 130 but it is understood that the central server 108 may be capable of communicating with many more social networking servers. The central server 108 may contain the appropriate protocols, user provided login credentials, and APIs for accessing each of the social networking servers according to its own protocol.

It is contemplated that the system of the present disclosure can be adapted to communicate with any social networking server that allows for connections from third party applications through the Internet 110. Present day examples of such social networking services include, but are not limited to, Facebook, Twitter, Myspace, Flickr, Digg, Reddit, and many others. Each of the various social networking services may allow its users to authenticate or login from various different types of devices. In the present embodiment, the social networking servers 120, 130 are each shown connecting to a mobile telephone, a tablet computer and a laptop computer but it is understood that these are only exemplary, and many other types of devices may be utilized. Furthermore, in the present embodiment the social networking servers 120, 130 function as query servers. That is to say that the present system may operate with any server that allows a user to post a query that may be responded to by posts from a third party.

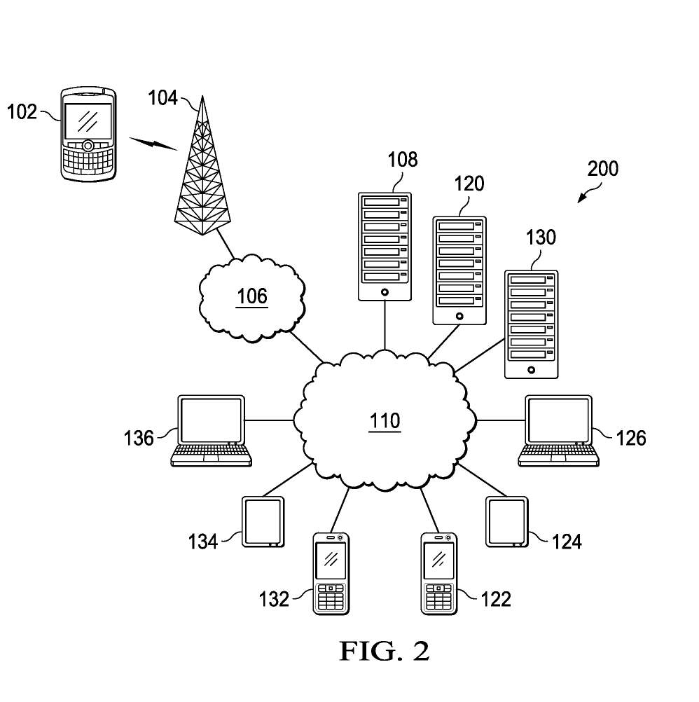

Referring now to FIG. 2 another schematic diagram of a communications system 200 according to aspects of the present disclosure is shown. It can be seen that it is possible that most or all of the entities shown in FIG. 1 may actually communicate with one another via the Internet 110. For example, the user devices 122, 124, 126 may actually interact with the social networking server 120 via the Internet 110. Similarly, the user devices 132, 134, 136 may communicate with social networking server 130 via the Internet 110. It is also possible that any single user device (mobile phone 122 for example) may actually be able to communicate with both social networking servers 120, 130. In the present embodiment, the cellular data network 126 may communicate with the central server 108 via the Internet as well. It will be appreciated that the present disclosure is not meant to be limited to the particular way in the which the various servers and networks intercommunicate so long as appropriate protocols are followed allowing for reliable exchange of data and information.

In operation, the systems as shown in FIGS. 1 and 2 can provide the ability for the user of the mobile device 102 to simultaneously post one or more queries to each social networking server 120, 130. As described above, there may be many social networking servers associated with the mobile device 102 and the device 102 may have the option of posting the query to all, or a subset, of the available social networking servers. Although complex queries are within the scope of the present disclosure, in the present example, the mobile device user may use the mobile device 102 to provide a simple query. Non-limiting examples of such queries would include a request for a local service such as a car wash or dry cleaner. Another example would be a request for a particular type of food available within a certain area. Yet another useful, and perhaps time sensitive query, that can be addressed by the system of the present disclosure would be a request for a last minute babysitter.

The query will be transmitted from the mobile device 102 via one or more wireless towers 104 to the cellular data network 106. The query will be received by the central server 108, which will then post the query to each of the preselected social networking sites 120, 130 via the Internet 110. Location information may also be provided by the mobile device 102 and may be posted on the social networking servers 120, 130.

Social networking sites often allow users to associate themselves with certain other users as friends or contact. Subgroups of friend or contacts may also sometimes be designated within a social networking system. All friends, or a group of friend, may be selected to receive the a query. In one embodiment, the query will simply be posted to the user's associated profile or status on one or more of the social networking servers 120, 130. It is contemplated that after a period of time, or perhaps after being notified of the query by the social networking servers 120, 130, that one or more of the users' contacts or friends will respond to the query. Using Facebook as an example, the user may post on his or her status that he or she is looking for a place to receive a manicure near their current location. In some embodiments, the location will be provided as a part of the query from the user, and in other embodiments, the central server 108 will automatically provide the location of the querying user from data obtained automatically through the data network 106 from the mobile device 102.

Friends or contacts who see the status message or query and elect to respond will typically post a response on the server that will be associated with the original status message or query. Monitoring the ongoing status message conversation is one way that the central server 108 can detect responses to the query. The central server 108 may continuously or periodically monitor the one or more social networking servers 120, 130 waiting for a response. Responses may be reported back to the user of the mobile device 102 as they occur, or they may be collated and transmitted after a predetermined period of time.

In some embodiments, the query may only be useful for a particular period of time, in which case the central server 108 may remove the query or provide an update on the social networking site indicating that answers to the particular query are no longer useful. Whether or not a time limit is to be associated with a particular query may be determined by the user of the mobile device 102.

It is also contemplated that a mobile device user may wish to issue follow up queries or replies to any responses received. In some embodiments, this can be handled in the same thread as the original query. For example, a user of the mobile device 102 may issue a note of thanks, or a follow up query (e.g., “has anyone else used this baby sitter?”) that is issued to the central server 108, and then on to the social networking servers 120, 130 for posting in the same conversation, status message, or thread as the original query. In another embodiment, the follow on query may be posted as an entirely new query.

It will be appreciated that just as the central server 108 may communicate with multiple social networking servers 120, 130, that the central server 108 may be adaptable to communicate with a plurality of different types of mobile devices 102. A mobile device 102 may be loaded with a set of software that enables the mobile device 102 to communicate with the central server 108. It is also understood that the mobile device 102 need not necessarily be mobile but could be a stationary computer, for example, in an office building. In such case, the user's device may not communicate via the cellular system 104 and cellular data network 106 but could communicate with central server 108 directly over the Internet 110.

The central server 108 is highly adaptable in the methods that may be used to communicate with the mobile device 102. For example, in some embodiments, the mobile device 102 will be a SMS or MMS capable cell phone that submits a query via a traditional cell phone network. The central server 108 may then accept the text message, formulate it into an appropriate query for posting on the social networking servers 120, 130, and await a response as described above. When one or more responses are received, these may be transmitted back to the mobile device 102 also via text or other messaging service. Similarly, the central server 108 could accept queries via email and respond via email, text, or other means when answers are received.

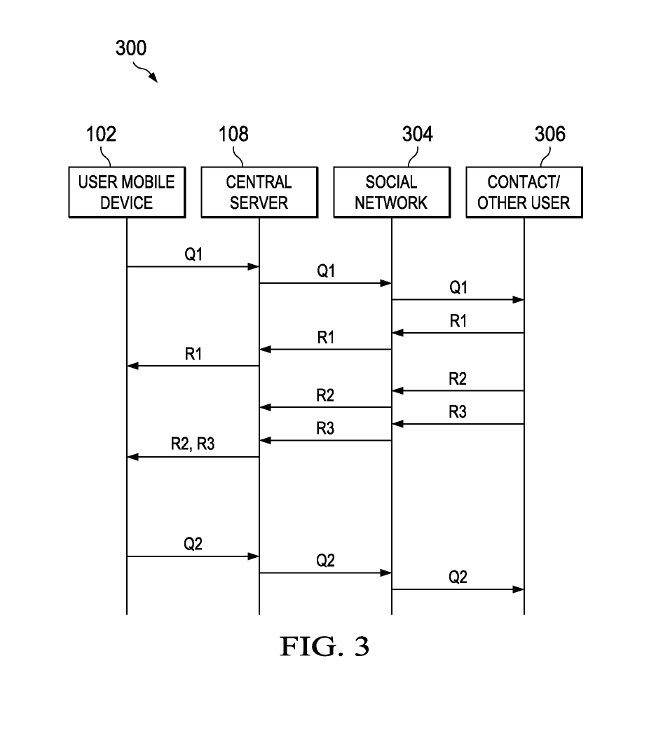

Referring now to FIG. 3, a sequence diagram illustrating one possible sequence of communications within the aforedescribed systems is shown. In FIG. 3, a user, via mobile device 102 submits a query Q1 to the central server 108. For simplicity, the various methods that may be utilized to submit queries to the central server 108 will not be repeated here. The central server 108 then forwards the query Q1 on to various social networking sites. In the present embodiment, a single social networking site 304 is shown but it is understood that the central server 108 may simultaneously transmit queries to multiple social networking servers or sites.

As a plurality of social networking site users 306 view various updates that may be available on the social networking site, the query Q1 is received by one or more users 306. A response R1 is posted by a user to the social networking server 304. This may be transmitted back to the central server 108. In the present example, the response R1 is transmitted immediately back to the user 302.

To further illustrate the handling of multiple responses, a second response R2 is posted by the one or more users 306 to the social networking server 304. This response R2 may be transmitted back to the central server 108. However, the networking server also receives a third response R3 from another of the users 306. This response R3 may also be received by the central server 108. In the second example, the central server 108 collates both responses R2 and R3 before returning then to the user 302. Whether or not answers are collated or combined before being returned to a user may be selectable at the option of the user.

In addition to the query and responses, replies may be issued by the user of the mobile device 102. In FIG. 3 the reply is shown as Q2, and may or may not contain additional or follow on queries. As with the original query Q1, the reply/query Q2 is forwarded to the central server 108 and then to the social network 304. It may then be posted by the social network 304 in the same conversation thread as the original query Q1 such that the query, responses, and replies or further queries may be presented to all users as a single conversation thread. The mobile device 102 may collate all the responses in an organized fashion for the user.

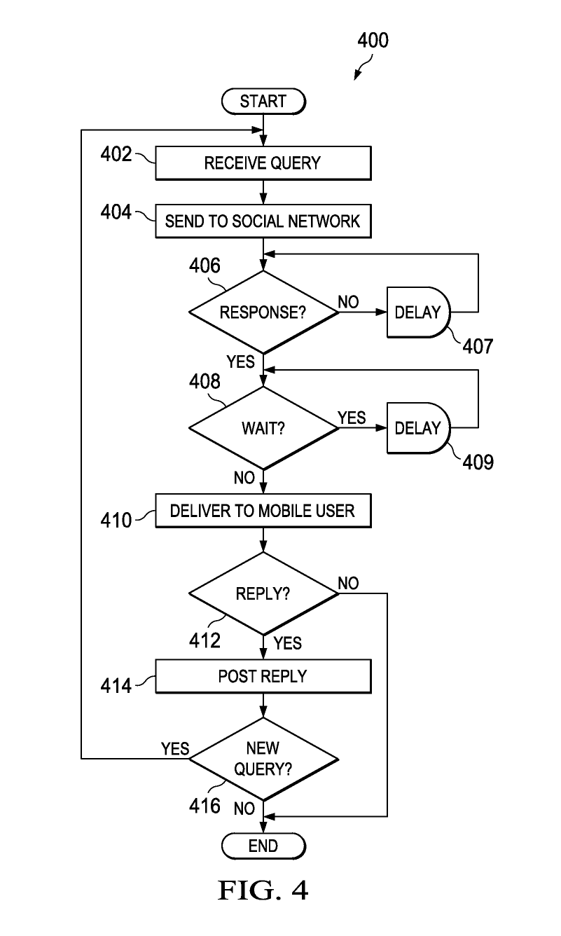

Referring now to FIG. 4 a flowchart 400 depicting one embodiment of a method of operation of the communications systems described above is shown. At step 402, a query is received at the central server 108. At step 404, the query is sent by the central server to a social networking server (e.g., 120 of FIG. 2). At step 406, the central server 108 may query the social networking site to determine if a response has been received. (In other embodiments, the social networking server 120 may provide an update to the central server 108 when a response is received.) In the present embodiment, the central server 108 will take no further action until the response is received on the social networking site as shown by delay 407 and its associated loop back to step 406. When a response is received, a determination may be made at step 408 to wait for more responses. In some cases, a single response will be propagated back to the user as soon as it is received and in other embodiments, the central server 108 may wait for a plurality of responses for a predetermined time before returning such responses to the user. This is shown by the delay at step 409 and its associated loop back to step 408. At step 410, the responses are delivered back to the user or the original issuer of the query. As described, multiple responses may be collated.

At step 412, a user may have the option of submitting a reply, or additional or follow on query, in response to responses received at step 410. The reply may be posted back to the central server 108 at step 414. In some cases, this may be the end of the activity. However, at step 416 it may be determined whether the reply from step 414 also contains an additional query. In this case, in some embodiments, the steps 402 through 412 may be repeated in order that any additional responses can be taken into account and delivered to the user.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A communications system comprising:
a central server that communicates with a plurality of query servers for exchanging queries and receiving query responses; and
a querying device that communicates with the central server to send queries thereto and receive query responses therefrom;
wherein the querying device sends a query to the central server that posts the query to each of the plurality of query servers;
wherein at least one third party provides a query response to the query on at least one of the plurality of query servers; and
wherein the central server receives the response to the query from the at least one of the plurality of query servers and provides the response to the querying device.

2. The communication system of claim 1, wherein the central server obtains location data from the querying device when receiving the query.

3. The communication system of claim 2, wherein the central server provides the location data as a part of the query posted to the plurality of query servers.

4. The communication system of claim 1, wherein at least one of the plurality of query servers is a social networking server.

5. The communication system of claim 1, wherein the querying device is a mobile computing device.

6. The communication system of claim 1, wherein the querying device is a stationary computing device.

7. The communication system of claim 1, wherein the querying device communicates with the central server via a mobile phone network.

8. The communication system of claim 1, wherein the querying device communicates with the central server via the Internet.

9. The communication system of claim 1 wherein each of the plurality of query servers receives login credentials from the central server corresponding to a user issuing the query from the querying device.

10. The communications system of claim 1, wherein the querying device supplies a reply to at least one response, and the central server receives the reply and sends it to the plurality of query servers.

11. The communication system of claim 10, wherein the reply contains a second query.

12. A communication system comprising:
a central server in communication with a mobile computing device and a plurality of social networking servers;
wherein the central server obtains authentication credentials from a mobile device user via the mobile device and supplies the credentials to the social networking servers to access a user profile associated with the mobile device user on the social networking servers;
wherein the central server obtains a query from the mobile device user and posts the query to the user's profile on each of the plurality of social networking servers; and
wherein the central server monitors for responses to the queries on the social networking sites and returns the responses to the mobile computing device.

13. The communication system of claim 12, wherein the central server obtains location data from the mobile computing device when receiving a query and provides the location data to the social network site.

14. The communication system of claim 13, wherein the central server retains responses to the query along with the location data and provides the retained information to a second user in response to a second similar query when the second user's location data indicates a predetermined proximity to the first user's location.

15. The communication system of claim 12, wherein the mobile computing device communicates with the central server via a mobile phone network.

16. The communication system of claim 12, wherein the mobile computing device is a smart phone.

17. A method of querying social networking sites comprising:
receiving at a central server a query from a user;
providing the query to a plurality of social networking sites under a profile associated with the user;
receiving responses to the query from the plurality of social networking servers, the queries being provided by contacts associated with the users profile; and
returning the query response to the user.

18. The method of claim 17, wherein the user provides the query via a mobile computing device.

19. The method of claim 17, further comprising obtaining location data corresponding to the user and providing the data to the social networking servers.

20. The method of claim 17, further comprising receiving at the central server response to the reply from the user and providing the reply to the plurality of social networking sites under the profile associated with the user.
